(19) United States
(12) Patent Application Publication
(10) Pub. No.: US 2025/0112716 A1
(43) Pub. Date: Apr. 3, 2025

(54) CONFIGURATION METHOD AND APPARATUS FOR DUAL-MODE CONVERGED COMMUNICATION, AND DUAL-MODE CONVERGED COMMUNICATION SYSTEM

(71) Applicants: BEIJING SMARTCHIP MICROELECTRONICS TECHNOLOGY COMPANY LIMITED, Beijing (CN); BEIJING SMARTCHIP SEMICONDUCTOR TECHNOLOGY COMPANY LIMITED, Beijing (CN)

(72) Inventors: Zheng Li, Beijing (CN); Qixin Gao, Beijing (CN); Kunpeng Xu, Beijing (CN); Hongguang Dai, Beijing (CN); Qian Zhang, Beijing (CN); Xianhui Wang, Beijing (CN); Weiqi Hao, Beijing (CN); Zhanxia Wu, Beijing (CN)

(21) Appl. No.: 18/833,397

(22) PCT Filed: Aug. 14, 2023
(86) PCT No.: PCT/CN2023/112891

§ 371 Date: Jul. 26, 2024

(30) Foreign Application Priority Data
Oct. 20, 2022 (CN) 202211284306.5

(51) Int. Cl. H04B 17/382; H04B 3/54; H04B 17/345

(52) U.S. Cl. CPC H04B 17/382; H04B 3/54; H04B 17/345

(57) ABSTRACT

Provided are a configuration method and apparatus for dual-mode converged communication, and a dual-mode converged communication system. The method includes: determining a first operating frequency band of power line communication (PLC) and a second operating frequency band of radio frequency (RF) communication; and configuring a second frequency band number of the second operating frequency band based on a first frequency band number of the first operating frequency band, such that a high-order harmonic frequency of a first operating clock of the PLC and a high-order harmonic frequency of a second operating clock of the RF communication do not overlap with the first operating frequency band or the second operating frequency band. This can reduce an impact of multiplicative noise generated by harmonic superposition and an impact of noise generated by a CPU during operation on performance of a dual-mode converged communication unit, improving transmission efficiency of dual-mode converged communication.

### TECHNICAL FIELD

The present disclosure relates to the technical field of communications, and specifically, to a configuration method and apparatus for dual-mode converged communication, and a dual-mode converged communication system.

### BACKGROUND

A new power system requires a power grid to have a capability of “source-load interaction”, and there is a great demand for Internet of Things (IoT) communication applications in various “source-network-load” links. Communication access for intelligent electricity distribution and consumption of the new power system has characteristics of a complex application environment, diverse business carrying requirements, a high transmission reliability requirement, a wide terminal distribution area, a plurality of measurement and monitoring points, and susceptibility to distribution network expansion and urban construction. Therefore, any communication method alone (power line communication (PLC)/high-speed PLC (HPLC), radio frequency (RF) communication, or the like) cannot fully meet requirements of an electricity distribution and consumption communication system.

A current mainstream solution is to build a local communication network by using a dual-mode communication method that combines the PLC and the RF communication. An RF communication technology and a PLC/HPLC technology complement each other to effectively avoid a blind spot of meter reading and a communication island when only the HPLC or the RF communication is adopted, thereby ensuring real-time, stable, and reliable data collection.

A dual-mode communication system adopts the PLC and the RF communication for networking. In a dual-mode network, both the PLC and the RF communication use dual channels for networking, and synchronous meter reading can be achieved using the PLC and the RF communication in parallel. In addition, weight allocation is carried out based on a priority strategy. A channel with a low node hierarchy, a high communication success rate, and a low delay is preferentially used for the meter reading. Although the RF communication technology has a certain complementary effect on the PLC technology, due to a low transmission rate, an existing RF communication network is unable to cooperate with a PLC network to achieve a rate-matched double-transceiving function, and cannot select a channel through intelligent routing to switch a communication mode. In most cases, a communication node in the network only works in one mode at one time point, and different manufacturers cannot achieve interconnection and interworking in an existing mode. As a result, a product is greatly limited in application and cannot be applied on a large scale.

An existing dual-mode dual-channel convergence technology has two main drawbacks: On one hand, although the power line carrier and the RF can work simultaneously, there is only one mode for communication at one time point. As a result, the rate-matched double-transceiving function cannot be achieved through cooperation with the PLC network, and the channel cannot be selected through the intelligent routing to switch the communication mode. On the other hand, during operation, an existing circuit of the PLC has a significant impact on transmission performance of a channel of the RF communication, which reduces reception sensitivity of the RF communication, shortens a communication distance, and lowers transmission efficiency.

### SUMMARY

An objective of embodiments of the present disclosure is to provide a configuration method and apparatus for dual-mode converged communication, and a dual-mode converged communication system, to resolve a problem of low transmission efficiency in dual-mode communication in the prior art.

In order to achieve the above objective, a first aspect of the present disclosure provides a configuration method for dual-mode converged communication, where the dual-mode converged communication includes PLC and RF communication, and the configuration method includes:
determining a first operating frequency band of the PLC and a second operating frequency band of the RF communication; and
configuring a second frequency band number of the second operating frequency band based on a first frequency band number of the first operating frequency band, to enable a high-order harmonic frequency of a first operating clock of the PLC and a high-order harmonic frequency of a second operating clock of the RF communication not to overlap with the first operating frequency band or the second operating frequency band.

In the embodiments of the present disclosure, the configuring a second frequency band number of the second operating frequency band based on a first frequency band number of the first operating frequency band, such that a high-order harmonic frequency of a first operating clock of the PLC and a high-order harmonic frequency of a second operating clock of the RF communication do not overlap with the first operating frequency band or the second operating frequency band includes:
obtaining the first frequency band number of the first operating frequency band;
searching a frequency band number configuration table based on the first frequency band number, where the frequency band number configuration table includes a combined frequency band number including the first frequency band number and the second frequency band number, and a first operating clock and a second operating clock that correspond to the combined frequency band number;
determining whether high-order harmonic frequencies of a first operating clock and a second operating clock that correspond to any combined frequency band number fall within the first operating frequency band and the second operating frequency band;
when determining that the high-order harmonic frequencies of the first operating clock and the second operating clock that correspond to the any combined frequency band number do not fall within the first operating frequency band or the second operating frequency band, determining a second frequency band number in the any combined frequency band number as a candidate second frequency band number; and
configuring any candidate second frequency band number as the second frequency band number.

In the embodiments of the present disclosure, the configuration method further includes:
establishing the frequency band number configuration table.

In the embodiments of the present disclosure, the establishing the frequency band number configuration table includes:
permuting and combining the first frequency band number and the second frequency band number to obtain a plurality of combined frequency band numbers; and
determining a first operating clock and a second operating clock that correspond to each of the combined frequency band numbers.

In the embodiments of the present disclosure, the determining a first operating clock and a second operating clock that correspond to each of the combined frequency band numbers includes:
obtaining a first clock frequency of the PLC and a second clock frequency of the RF communication;
obtaining a first frequency doubling coefficient, a first frequency division coefficient, a second frequency doubling coefficient, and a second frequency division coefficient for each combined frequency band number;
determining the first operating clock based on the first frequency doubling coefficient, the first frequency division coefficient, and the first clock frequency; and
determining the second operating clock based on the second frequency doubling coefficient, the second frequency division coefficient, and the second clock frequency.

In the embodiments of the present disclosure, the first operating clock meets a formula (1):

$${f}_{wk - PLC} = {P}_{PLC} / {Q}_{PLC} {f}_{osc - PLC} ; \qquad ( 1 )$$

where f_{wk-PLC} represents the first operating clock, P_{PLC} represents the first frequency doubling coefficient, Q_{PLC} represents the first frequency division coefficient, and f_{osc-PLC} represents the first clock frequency.

In the embodiments of the present disclosure, the second operating clock meets a formula (2):

$${f}_{wk - RF} = {P}_{RF} / {Q}_{RF} * {f}_{osc - RF} \qquad ( 2 )$$

where f_{wk-RF} represents the second operating clock, P_{RF} represents the second frequency doubling coefficient, Q_{RF} represents the second frequency division coefficient, and f_{osc-RF} represents the second clock frequency.

In the embodiments of the present disclosure, the configuration method further includes:
rating a neighboring station (STA) of a current STA to obtain an alternative proxy STA;
determining whether a communication success rate of a main proxy STA corresponding to the current STA is greater than a first threshold;
when the communication success rate of the main proxy STA is greater than the first threshold, determining whether a delay of the main proxy STA is less than a second threshold; and
when the delay of the main proxy STA is less than the second threshold, selecting the main proxy STA to send data.

In the embodiments of the present disclosure, the configuration method further includes:
when the communication success rate of the main proxy STA is less than or equal to the first threshold and/or the delay of the main proxy STA is greater than or equal to the second threshold, selecting the alternative proxy STA to send the data.

In the embodiments of the present disclosure, the rating a neighboring STA of a current STA to obtain an alternative proxy STA includes:
determining a proxy quality rating of the neighboring STA of the current STA based on an uplink communication success rate, signal strength, a signal-to-noise ratio, a hierarchy, and a quantity of transmitted data frames that are of the neighboring STA;
sorting the neighboring STA in a descending order based on the proxy quality rating; and
selecting a preset quantity of top-ranked neighboring nodes as the alternative proxy STA.

In the embodiments of the present disclosure, the configuration method further includes:
physically isolating the PLC and the RF communication.

In the embodiments of the present disclosure, the physically isolating the PLC and the RF communication includes:
disposing a power interference suppression circuit separately in a transceiver circuit of the PLC, a transceiver circuit of the RF communication, and a carrier power amplifier.

In the embodiments of the present disclosure, the physically isolating the PLC and the RF communication includes:
disposing a digital baseband and a trench between a chip of the PLC and a chip of the RF communication to spatially isolate the chip of the PLC and the chip of the RF communication.

In the embodiments of the present disclosure, the physically isolating the PLC and the RF communication includes:
setting an RF antenna, an RF filtering communication circuit, and a high-speed carrier power line coupling loop to be spatially separated, where the RF antenna is a spring antenna.

In the embodiments of the present disclosure, the physically isolating the PLC and the RF communication includes:
disposing a switching power supply circuit and a transceiver circuit of the RF communication in different planes.

In the embodiments of the present disclosure, the configuration method further includes:
optimizing a peripheral operating frequency of a central processing unit (CPU) and a filtering parameter of a power pin.

In the embodiments of the present disclosure, the optimizing a peripheral operating frequency of a CPU and a filtering parameter of a power pin includes:
connecting the power pin and a resistor in series; and/or
connecting the power pin and a capacitor in parallel.

In the embodiments of the present disclosure, the capacitor is a 100 nF capacitor and/or a 100 pF capacitor.

In the embodiments of the present disclosure, the configuration method further includes:
disposing a bandpass filter on a transmitting loop of the PLC.

In the embodiments of the present disclosure, the bandpass filter is a sixth-order bandpass filter, and the sixth-order bandpass filter includes a third-order high-pass filter (HPF) and a third-order low-pass filter (LPF).

In the embodiments of the present disclosure, inductance of the third-order HPF is 16.93 uH, capacitance of the third-order HPF is 3.38 nF, inductance of the third-order LPF is 15.6 nH, and capacitance of the third-order LPF is 12.5 pF.

A second aspect of the present disclosure provides a configuration apparatus for dual-mode converged communication, where the dual-mode converged communication includes PLC and RF communication, and the configuration apparatus includes:
a determining module configured to determine a first operating frequency band of the PLC and a second operating frequency band of the RF communication; and
a configuration module configured to configure a second frequency band number of the second operating frequency band based on a first frequency band number of the first operating frequency band, to enable a high-order harmonic frequency of a first operating clock of the PLC and a high-order harmonic frequency of a second operating clock of the RF communication not to overlap with the first operating frequency band or the second operating frequency band.

In the embodiments of the present disclosure, the configuration module is further configured to:
obtain the first frequency band number of the first operating frequency band;
search a frequency band number configuration table based on the first frequency band number, where the frequency band number configuration table includes a combined frequency band number including the first frequency band number and the second frequency band number, and a first operating clock and a second operating clock that correspond to the combined frequency band number;
determine whether high-order harmonic frequencies of a first operating clock and a second operating clock that correspond to any combined frequency band number fall within the first operating frequency band and the second operating frequency band;
when determining that the high-order harmonic frequencies of the first operating clock and the second operating clock that correspond to the any combined frequency band number do not fall within the first operating frequency band or the second operating frequency band, determine a second frequency band number in the any combined frequency band number as a candidate second frequency band number; and
configure any candidate second frequency band number as the second frequency band number.

In the embodiments of the present disclosure, the configuration apparatus further includes:
an establishment module configured to establish the frequency band number configuration table.

In the embodiments of the present disclosure, the establishment module is further configured to:
permute and combine the first frequency band number and the second frequency band number to obtain a plurality of combined frequency band numbers; and
determine a first operating clock and a second operating clock that correspond to each of the combined frequency band numbers.

In the embodiments of the present disclosure, the establishment module is further configured to:
obtain a first clock frequency of the PLC and a second clock frequency of the RF communication;
obtain a first frequency doubling coefficient, a first frequency division coefficient, a second frequency doubling coefficient, and a second frequency division coefficient for each combined frequency band number;
determine the first operating clock based on the first frequency doubling coefficient, the first frequency division coefficient, and the first clock frequency; and
determine the second operating clock based on the second frequency doubling coefficient, the second frequency division coefficient, and the second clock frequency.

In the embodiments of the present disclosure, the configuration apparatus further includes:
a rating module configured to rate a neighboring STA of a current STA to obtain an alternative proxy STA;
a first judgment module configured to determine whether a communication success rate of a main proxy STA corresponding to the current STA is greater than a first threshold;
a second judgment module configured to: when the communication success rate of the main proxy STA is greater than the first threshold, determine whether a delay of the main proxy STA is less than a second threshold; and
a first selection module configured to: when the delay of the main proxy STA is less than second threshold, select the main proxy STA to send data.

In the embodiments of the present disclosure, the configuration apparatus further includes:
a second selection module configured to: when the communication success rate of the main proxy STA is less than or equal to the first threshold and/or the delay of the main proxy STA is greater than or equal to the second threshold, select the alternative proxy STA to send the data.

In the embodiments of the present disclosure, the rating module is further configured to:
determine a proxy quality rating of the neighboring STA of the current STA based on an uplink communication success rate, signal strength, a signal-to-noise ratio, a hierarchy, and a quantity of transmitted data frames that are of the neighboring STA;
sort the neighboring STA in a descending order based on the proxy quality rating; and
select a preset quantity of top-ranked neighboring nodes as the alternative proxy STA.

A third aspect of the present disclosure provides a dual-mode converged communication system, where the dual-mode converged communication system is configured by using the above configuration method for dual-mode converged communication.

According to the above technical solutions, an operating frequency band of dual-mode communication is configured, and a second frequency band number of a second operating frequency band is configured based on a first frequency band number of a first operating frequency band, such that a high-order harmonic frequency of a first operating clock of PLC and a high-order harmonic frequency of a second operating clock of RF communication do not overlap with the first operating frequency band or the second operating frequency band. In this way, operating frequencies of the PLC and the RF communication do not overlap. This can reduce an impact of multiplicative noise generated by harmonic superposition and an impact of noise generated by a CPU during operation on performance of a dual-mode converged communication unit, thereby improving transmission efficiency of dual-mode converged communication.

Other features and advantages of the embodiments of the present disclosure are described in detail in the following DETAILED DESCRIPTION OF THE EMBODIMENTS part.

### BRIEF DESCRIPTION OF THE DRAWINGS

The accompanying drawings are provided for further understanding of the embodiments of the present disclosure, and constitute a part of the specification. The accompanying drawings and the following specific implementations are intended to explain the embodiments of the present disclosure, rather than to limit the embodiments of the present disclosure. In the accompanying drawings:

FIG. 1 is a schematic flowchart of a configuration method for dual-mode converged communication according to an embodiment of the present disclosure;

FIG. 2 is a schematic flowchart of a configuration method for dual-mode converged communication according to another embodiment of the present disclosure;

FIG. 3 is a schematic structural diagram of a physical channel of dual-mode converged communication according to an embodiment of the present disclosure;

FIG. 4 is a schematic structural diagram of a circuit of dual-mode converged communication according to an embodiment of the present disclosure;

FIG. 5 is a schematic structural diagram of a layout of a dual-mode chip according to an embodiment of the present disclosure; and

FIG. 6 is a schematic structural diagram of a layout of a dual-mode converged communication unit according to an embodiment of the present disclosure.

### DETAILED DESCRIPTION

In order to make the objectives, technical solutions, and advantages of the embodiments of the present disclosure clear, the technical solutions in the embodiments of the present disclosure are clearly and completely described below with reference to the accompanying drawings in the embodiments of the present disclosure. Apparently, the described specific implementations are intended to describe and explain the embodiments of the present disclosure, rather than to limit the embodiments of the present disclosure. All other embodiments obtained by those of ordinary skill in the art based on the embodiments of the present disclosure without creative efforts should fall within the protection scope of the present disclosure.

It should be noted that all the directional indications (such as upper, lower, left, right, front, and back) in the embodiments of the present disclosure are merely used to explain a relative position relationship, motion situations, and the like of the components in a specific gesture (as shown in the figures). If the specific gesture changes, the directional indications also change accordingly.

Moreover, the terms such as “first” and “second” described in the embodiments of the present disclosure are used herein only for the purpose of description and are not intended to indicate or imply relative importance, or implicitly indicate a quantity of the indicated technical features. Therefore, features defined by “first” and “second” may explicitly or implicitly include at least one of the features. Furthermore, the technical solutions between the various embodiments may be combined with each other, but must be on the basis that the combination thereof can be implemented by a person of ordinary skill in the art. In case of a contradiction with the combination of the technical solutions or a failure to implement the combination, it should be considered that the combination of the technical solutions does not exist, and is not within the protection scope of the present disclosure.

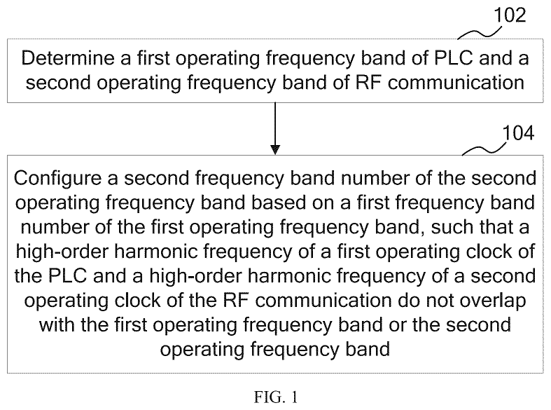

FIG. 1 is a schematic flowchart of a configuration method for dual-mode converged communication according to an embodiment of the present disclosure. As shown in FIG. 1, in an embodiment of the present disclosure, the configuration method for dual-mode converged communication is provided. The dual-mode converged communication includes PLC and RF communication, and the configuration method includes following steps:

Step 102: Determine a first operating frequency band of the PLC and a second operating frequency band of the RF communication.

Step 104: Configure a second frequency band number of the second operating frequency band based on a first frequency band number of the first operating frequency band, such that a high-order harmonic frequency of a first operating clock of the PLC and a high-order harmonic frequency of a second operating clock of the RF communication do not overlap with the first operating frequency band or the second operating frequency band.

In the embodiments of the present disclosure, dual-mode communication is dual-mode converged dual-channel communication, which may include the PLC and the RF communication. Dual channels may include a transmit-receive channel of the PLC and a transmit-receive channel of the RF communication. The two transmit-receive channels are independently controlled and can be used for transmission simultaneously or not simultaneously. Receivers of the two transmit-receive channels can be started simultaneously to receive and demodulate a signal sent through any channel. In existing dual-mode communication, there is only one mode for communication at one time point. As a result, a rate-matched double-transceiving function cannot be achieved through cooperation with a PLC network, and a channel cannot be selected through intelligent routing to switch a communication mode. In addition, during operation, an existing circuit of the PLC has a significant impact on transmission performance of a channel of the RF communication, which reduces reception sensitivity of the RF communication, shortens a communication distance, and lowers transmission efficiency.

Therefore, the embodiments of the present disclosure propose an interference suppression design method for the dual-mode converged communication. Operating clocks of the PLC and the RF communication are separately configured through frequency avoidance, such that the operating clocks are in different clock domains. This reduces an impact of a high-order harmonic of the circuit of the circuit on the reception sensitivity of the RF communication. In the embodiments of the present disclosure, the PLC may be HPLC, and the RF communication may be high-speed radio frequency (HRF) communication. Specifically, a processor can first determine an operating frequency band of the PLC and an operating frequency band of the RF communication. The operating frequency band of the PLC is the first operating frequency band, and the operating frequency band of the RF communication is the second operating frequency band. In an example, the first operating frequency band may include N optional first operating frequency bands [fₚ₁₋ᵢ, fₚ₂₋ⱼ], where i=1, 2, . . . , and N. The second operating frequency band may include M optional second operating frequency bands [f_{w1-i}, f_{w2-j}], where j=1, 2, . . . , and M. The first operating frequency band may include a plurality of first frequency band numbers, and the second operating frequency band may include a plurality of second frequency band numbers. Each first frequency band number and each second frequency band number can be combined to form a combined frequency band number. For example, assuming that the first operating frequency band includes four first frequency band numbers, namely I₀, I₁, I₂, and I₃, and the second operating frequency band number includes three second frequency band numbers, namely J₀, J₁, and J₂, 12 combined frequency band numbers can be formed. Each combined frequency band number has a corresponding first operating clock and second operating clock. The first operating clock is an operating clock of the PLC, and the second operating clock is an operating clock of the RF communication. The processor can configure one second frequency band number based on the obtained first frequency band number, such that both the first operating clock and the second operating clock do not overlap with the first operating frequency band or the second operating frequency band. This can reduce an impact of multiplicative noise generated by harmonic superposition and an impact of noise generated by a CPU during operation on performance of a dual-mode converged communication unit, thereby improving transmission efficiency of the dual-mode converged communication. In an example, the processor can first determine a first frequency band number i of the PLC, where a corresponding transmitting frequency band is [fₚ₁₋ᵢ, fₚ₂₋ⱼ], and corresponding 1 to A high-order harmonics are respectively [fₚ₁₋ᵢ, fₚ₂₋ⱼ], . . . , and [A×fₚ₁₋ᵢ, A×fₚ₂₋ⱼ]. Then an available second frequency band number j of the RF communication is determined based on the second operating clock corresponding to the combined frequency band number, where a corresponding transmitting frequency band is [f_{w1-i}, f_{w2-j}], such that 1 to A high-order harmonics of the first operating clock and the second operating clock do not fall within the first operating frequency band [fₚ₁₋ᵢ, fₚ₂₋ⱼ] or the second operating frequency band [f_{w1-i}, f_{w2-j}].

According to the above technical solutions, an operating frequency band of the dual-mode converged communication is configured, and the second frequency band number of the second operating frequency band is configured based on the first frequency band number of the first operating frequency band, such that the high-order harmonic frequency of the first operating clock of the PLC and the high-order harmonic frequency of a second operating clock of the RF communication do not overlap with the first operating frequency band or the second operating frequency band. In this way, operating frequencies of the PLC and the RF communication do not overlap. This can reduce the impact of the multiplicative noise generated by the harmonic superposition and the impact of the noise generated by the CPU during the operation on the performance of the dual-mode converged communication unit, thereby improving the transmission efficiency of the dual-mode converged communication.

In the embodiments of the present disclosure, the configuration method may further include:
establishing the frequency band number configuration table.

Specifically, the processor can permute and combine an existing frequency band based on the first operating frequency band of the PLC and the second operating frequency band of the RF communication to establish the frequency band number configuration table. The frequency band number configuration table may include the combined frequency band number including the first frequency band number and the second frequency band number, as well as the first operating clock and the second operating clock that correspond to the combined frequency band number. After the frequency band number configuration table is established, the processor can configure interference suppression based on a dual-channel operating clock calculated and generated in advance, and quickly match an optional second operating frequency band number based on a frequency band number of the first operating frequency band, so as to enable frequency avoidance in the PLC and the RF communication.

In the embodiments of the present disclosure, the establishing the frequency band number configuration table may include:
permuting and combining the first frequency band number and the second frequency band number to obtain a plurality of combined frequency band numbers; and
determining a first operating clock and a second operating clock that correspond to each of the combined frequency band numbers.

Specifically, as shown in Table 1, for example, the PLC has four first operating frequency bands, and the RF communication has three second operating frequency bands. If the first operating frequency band includes four first frequency band numbers, namely I₀, I₁, I₂, and I₃, and the second operating frequency band number includes three second frequency band numbers, namely J₀, J₁, and J₂, 12 combined frequency band numbers can be formed. For example, if the first frequency band number is 1 and the second frequency band number is 2, the combined frequency band number is I₁J₂, and corresponding first and second operating clocks are f_{wk-PLC6} and f_{wk-RF6}.

TABLE 1

| | First | Second | | | First | Second | First | Second |
|---|---|---|---|---|---|---|---|---|
| | frequency | frequency | First | Second | frequency | frequency | frequency | frequency |
| | band | band | operating | operating | doubling | division | doubling | division |
| | number | number | clock | clock | coefficient | coefficient | coefficient | coefficient |
| 1 | I₀ | J₀ | f_{wk-PLC1} | f_{wk-RF1} | P_{PLC00} | Q_{PLC00} | P_{RF00} | Q_{RF00} |
| 2 | | J₁ | f_{wk-PLC2} | f_{wk-RF2} | P_{PLC01} | Q_{PLC01} | P_{RF01} | Q_{RF01} |
| 3 | | J₂ | f_{wk-PLC3} | f_{wk-RF3} | P_{PLC02} | Q_{PLC02} | P_{RF02} | Q_{RF02} |
| 4 | I₁ | J₀ | f_{wk-PLC4} | f_{wk-RF4} | P_{PLC10} | Q_{PLC10} | P_{RF10} | Q_{RF10} |
| 5 | | J₁ | f_{wk-PLC5} | f_{wk-RF5} | P_{PLC11} | Q_{PLC11} | P_{RF11} | Q_{RF11} |
| 6 | | J₂ | f_{wk-PLC6} | f_{wk-RF6} | P_{PLC12} | Q_{PLC12} | P_{RF12} | Q_{RF12} |
| 7 | I₂ | J₀ | f_{wk-PLC7} | f_{wk-RF7} | P_{PLC20} | Q_{PLC20} | P_{RF20} | Q_{RF20} |
| 8 | | J₁ | f_{wk-PLC8} | f_{wk-RF8} | P_{PLC21} | Q_{PLC21} | P_{RF21} | Q_{RF21} |
| 9 | | J₂ | f_{wk-PLC9} | f_{wk-RF9} | P_{PLC22} | Q_{PLC22} | P_{RF22} | Q_{RF22} |
| 10 | I₃ | J₀ | f_{wk-PLC10} | f_{wk-RF10} | P_{PLC30} | Q_{PLC30} | P_{RF30} | Q_{RF30} |
| 11 | | J₁ | f_{wk-PLC11} | f_{wk-RF11} | P_{PLC31} | Q_{PLC31} | P_{RF31} | Q_{RF31} |
| 12 | | J₂ | f_{wk-PLC12} | f_{wk-RF12} | P_{PLC32} | Q_{PLC32} | P_{RF32} | Q_{RF32} |

In the embodiments of the present disclosure, the determining a first operating clock and a second operating clock that correspond to each of the combined frequency band numbers may include:
obtaining a first clock frequency of the PLC and a second clock frequency of the RF communication;
obtaining a first frequency doubling coefficient, a first frequency division coefficient, a second frequency doubling coefficient, and a second frequency division coefficient for each combined frequency band number;
determining the first operating clock based on the first frequency doubling coefficient, the first frequency division coefficient, and the first clock frequency; and
determining the second operating clock based on the second frequency doubling coefficient, the second frequency division coefficient, and the second clock frequency.

Specifically, the processor can first obtain a clock frequency of the dual-mode converged communication, where a clock frequency of the PLC is the first clock frequency f_{osc-PLC}, and a clock frequency of the RF communication is the second clock frequency f_{osc-RF}. Then, the first doubling frequency coefficient P_{PLC}, the first frequency division coefficient Q_{PLC}, the second frequency doubling coefficient P_{RF}, and the second frequency division coefficient Q_{RF} are obtained for each combined frequency band number. The first frequency doubling coefficient P_{PLC} and the first frequency division coefficient Q_{PLC} are respectively a frequency doubling coefficient and a frequency division coefficient of the PLC, while the second frequency doubling coefficient P_{RF} and the second frequency division coefficient Q_{RF} are respectively a frequency doubling coefficient and a frequency division coefficient of the RF communication. The first operating clock f_{wk-PLC} is obtained by performing frequency doubling and division on the first clock frequency f_{osc-PLC}, and the second operating clock f_{wk-RF} is obtained by performing the frequency doubling and division on the second clock frequency f_{osc-RF}.

In the embodiments of the present disclosure, the first operating clock meets a formula (1):

$${f}_{wk - PLC} = {P}_{PLC} / {Q}_{PLC} {f}_{osc - PLC} ; \qquad ( 1 )$$

In the above formula, f_{wk-PLC} represents the first operating clock, P_{PLC} represents the first frequency doubling coefficient, Q_{PLC} represents the first frequency division coefficient, and f_{osc-PLC} represents the first clock frequency.

In the embodiments of the present disclosure, the second operating clock meets a formula (2):

$${f}_{wk - RF} = {P}_{RF} / {Q}_{RF} * {f}_{osc - RF} \qquad ( 2 )$$

In the above formula, f_{wk-RF} represents the second operating clock, P_{RF} represents the second frequency doubling coefficient, Q_{RF} represents the second frequency division coefficient, and f_{osc-RF} represents the second clock frequency.

In the embodiments of the present disclosure, operating frequency bands corresponding to the first and second frequency band numbers in the frequency band number configuration table should ensure that 1 to B high-order harmonics of the first operating frequency band corresponding to each combined frequency band number do not overlap or least overlap with the second operating frequency band, so as to prevent a high-order harmonic of a signal of the PLC from interfering with the RF communication. For example, it is assumed that the first frequency band number is 1, which corresponds to a first operating frequency band of 2 MHz to 6 MHz; the second frequency band number is 2, which corresponds to a second operating frequency band of 480 MHz to 490 MHz; the first clock frequency f_{osc-PLC} is 25 MHz; and the second clock frequency f_{osc-RF} is 27 MHz. The 25 MHz clock frequency has 475 MHz and 500 MHz high-order harmonic frequencies in a range of 470 MHz to 510 MHz, and the 27 MHz clock frequency has a 486 MHz high-order harmonic frequency in the range of 470 MHz to 510 MHz. There is no overlapping high-order harmonic frequency between the two clock frequencies, avoiding the impact of the multiplicative noise generated by the harmonic superposition.

In the embodiments of the present disclosure, the first frequency doubling coefficient P_{PLC}, the first frequency division coefficient Q_{PLC}, the second frequency doubling coefficient P_{RF}, and the second frequency division coefficient Q_{RF} that correspond to each combined frequency band number can be calculated based on known parameters. It is assumed that P_{PLC}=48, Q_{PLC}=6, R_{PLC}=48, and Q_{RF}=9. Based on a parameter setting of a register, the first clock frequency is doubled to 1200 MHz, and the second clock frequency is doubled to 1296 MHz. Then, a frequency divider is used to perform frequency division, such that the first operating frequency band and the second operating frequency band do not overlap and respectively operate at 200 MHz and 144 MHz. When the first operating clock is at 200 MHz and an integer multiple of 200 MHz (400 MHz or 600 MHz), harmonic noise will be generated. When the second operating clock is at 144 MHz and an integer multiple of 144 MHz (432 MHz or 576 MHz), harmonic noise will be generated, which do not fall within the range of 470 MHz to 510 MHz. An appropriate configuration value selected in this way can be dynamically adjusted based on the operating frequency band to reduce the impact of the noise generated by the CPU during the operation on the performance of the dual-mode converged communication unit.

In the embodiments of the present disclosure, the configuring a second frequency band number of the second operating frequency band based on a first frequency band number of the first operating frequency band, such that a high-order harmonic frequency of a first operating clock of the PLC and a high-order harmonic frequency of a second operating clock of the RF communication do not overlap with the first operating frequency band or the second operating frequency band may include:
obtaining the first frequency band number of the first operating frequency band;
searching the frequency band number configuration table based on the first frequency band number, where the frequency band number configuration table includes the combined frequency band number including the first frequency band number and the second frequency band number, and the first operating clock and the second operating clock that correspond to the combined frequency band number;
determining whether high-order harmonic frequencies of a first operating clock and a second operating clock that correspond to any combined frequency band number fall within the first operating frequency band and the second operating frequency band;
when determining that the high-order harmonic frequencies of the first operating clock and the second operating clock that correspond to the any combined frequency band number do not fall within the first operating frequency band or the second operating frequency band, determining a second frequency band number in the any combined frequency band number as a candidate second frequency band number; and
configuring any candidate second frequency band number as the second frequency band number.

Specifically, in the embodiments of the present disclosure, the frequency band number configuration table can be established in advance. The frequency band number configuration table may include the combined frequency band number including the first frequency band number and the second frequency band number, as well as the first operating clock and the second operating clock that correspond to the combined frequency band number. The processor can search the frequency band number configuration table based on the obtained first frequency band number, and sequentially determine whether high-order harmonic frequencies of the first operating clock and the second operating clock that correspond to each combined frequency band number fall within the first operating frequency band and the second operating frequency band. If the high-order harmonic frequencies of the first operating clock and the second operating clock that correspond to the combined frequency band number do not fall within the first operating frequency band or the second operating frequency band, a second frequency band number in the combined frequency band number is determined as the candidate second frequency band number. Each first frequency band number may correspond to a plurality of candidate second frequency band numbers. Therefore, any one candidate second frequency band number can be selected for configuration, such that the high-order harmonic frequency of the first operating clock of the PLC and the high-order harmonic frequency of the second operating clock of the RF communication do not overlap with the first operating frequency band or the second operating frequency band. In this way, dynamic adjustment can be performed based on the operating frequency band to reduce the impact of the noise generated by the CPU during the operation on the performance of the dual-mode converged communication unit.

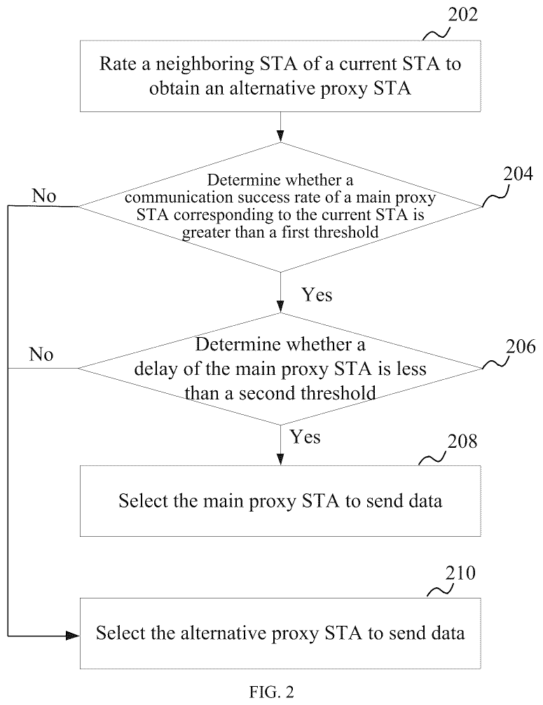

FIG. 2 is a schematic flowchart of a configuration method for dual-mode converged communication according to another embodiment of the present disclosure. As shown in FIG. 2, in the embodiments of the present disclosure, the configuration method may further include following steps:

Step 202: Rate a neighboring STA of a current STA to obtain an alternative proxy STA.

Step 204: Determine whether a communication success rate of a main proxy STA corresponding to the current STA is greater than a first threshold.

Step 206: When the communication success rate of the main proxy STA is greater than the first threshold, determine whether a delay of the main proxy STA is less than a second threshold.

Step 208: When the delay of the main proxy STA is less than the second threshold, select the main proxy STA to send data.

Step 210: When the communication success rate of the main proxy STA is less than or equal to the first threshold and/or the delay of the main proxy STA is greater than or equal to the second threshold, select the alternative proxy STA to send the data.

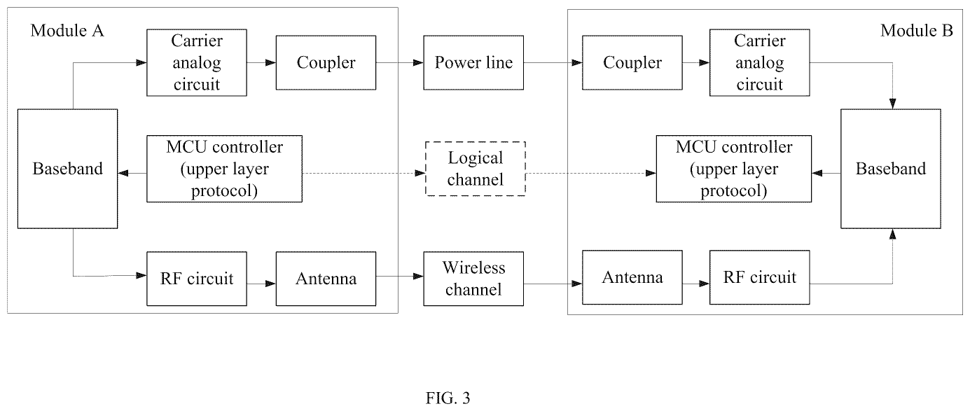

In the embodiments of the present disclosure, based on a principle of maximally rationalizing resource utilization, a dual-mode chip should be designed to use a mechanism that supports simultaneous transceiving for the PLC and the RF communication. Efficient data transmission is performed through physical layers of the PLC and the RF communication by using path backup, path optimization, load balancing, and other strategies at a transmitting end. FIG. 3 is a schematic structural diagram of a physical channel of the dual-mode converged communication according to an embodiment of the present disclosure. As shown in FIG. 3, a transmitting end of the PLC sends and couples a signal to a power line through a high-speed power line analog circuit, and a receiving end obtains data from the transmitting end through an analog circuit and a digital baseband. A transmitting end of the RF communication sends a signal through an RF circuit and radiates the signal into space through an antenna, and a receiving end obtains data from the transmitting end through an RF circuit and a digital baseband. From a perspective of the physical channel, the HPLC and the RF communication have independent transceivers and communication media, and there is small spatial interference between the HPLC and the RF communication.

After the dual-mode converged communication unit is networked, including a central coordinator (CCO) and all connected STAs, both a discovery list message of the PLC and a discovery list message of the RF communication need to be sent periodically based on a discovery list period parameter, where the discovery list message carries a network attribute of the current STA. Information such as a downlink reception rate, signal strength, and a signal-to-noise ratio is received from a neighboring node. A STA receives a discovery list message to obtain information of a neighboring node such as a rate of bidirectional communication with the neighboring node, signal strength, and a signal-to-noise ratio, such that the STA can select a more suitable relay proxy or back up a plurality of paths.

Due to a one-to-many communication mode between the CCO and the STA in power grid applications, a plurality of STAs can be selected as backup uplink proxies of the STA. When the communication success rate of a current STA with the main proxy STA is less than or equal to the first threshold and/or the delay of the main proxy STA is greater than or equal to the second threshold, the alternative proxy STAs can be sequentially selected to send the data. In an example, proxy quality of the neighboring STA can be rated first. Then a rating score of the neighboring STA is sorted, and a preset quantity of top-ranked neighboring STAs are selected as the alternative proxy STAs. For example, the top three STAs can be selected as the alternative proxy STAs. In the embodiments of the present disclosure, from a perspective of chip design, physical layer circuits of the HPLC and the RF communication are optimized. Based on the principle of maximally rationalizing resource utilization, the mechanism that supports simultaneous transceiving for the PLC and the RF communication can be used to perform the efficient data transmission through the physical layers of the PLC and the RF communication by using the path backup, path optimization, load balancing, and other strategies at the transmitting end.

It should be noted that, in the embodiments of the present disclosure, a method of first determining the communication success rate of the current STA with the main proxy STA and then determining the communication response delay, or a method of first determining the communication response delay and then determining the communication success rate of the current STA with the main proxy STA may be used. In the embodiments of the present disclosure, an example of first determining the communication success rate of the main proxy STA and then determining the communication response delay is used, which does not mean that the determining can only be made in this way.

In the embodiments of the present disclosure, the rating a neighboring STA of a current STA to obtain an alternative proxy STA in the step 202 may include:
determining a proxy quality rating of the neighboring STA of the current STA based on an uplink communication success rate, signal strength, a signal-to-noise ratio, a hierarchy, and a quantity of transmitted data frames that are of the neighboring STA;
sorting the neighboring STA in a descending order based on the proxy quality rating; and
selecting a preset quantity of top-ranked neighboring nodes as the alternative proxy STAs.

Specifically, a communication mode, an uplink communication success rate, signal strength, a signal-to-noise ratio, a hierarchy, and a quantity of transmitted data frames that are of the current STA can be used as measurement indexes to rate the proxy quality of the neighboring STA. In an example, a communication mode, the uplink communication success rate, the signal strength, the signal-to-noise ratio, the hierarchy, and the quantity of transmitted data frames that are of the neighboring STA can be normalized, and a weighted sum of each piece of data is the rating score of the neighboring STA. After that, the rating score of the neighboring STA is sorted in the descending order, and then the preset quantity of top-ranked neighboring STAs are selected as the alternative proxy STAs. For example, the top three neighboring STAs can be selected as the alternative proxy STAs. In the embodiments of the present disclosure, from the perspective of chip design, the physical layer circuits of the HPLC and the RF communication are optimized. Based on the principle of maximally rationalizing resource utilization, the mechanism that supports simultaneous transceiving for the PLC and the RF communication can be used to perform the efficient data transmission through the physical layers of the PLC and the RF communication by using the path backup, path optimization, load balancing, and other strategies at the transmitting end.

In the embodiments of the present disclosure, the configuration method may further include:
physically isolating the PLC and the RF communication.

Specifically, in chip and circuit design, the physical layer, a chip layout, and a communication unit circuit layout can be designed by deploying the PLC and the RF communication in different spatial planes to reduce spatial radiation interference. For example, a power interference suppression circuit can be separately disposed in a transceiver circuit of the PLC, a transceiver circuit of the RF communication, and a carrier power amplifier. Alternatively, a digital baseband and a trench may be disposed between a chip of the PLC and a chip of the RF communication to spatially isolate the chip of the PLC and the chip of the RF communication. Alternatively, an RF antenna, an RF filtering communication circuit, and a high-speed carrier power line coupling loop may be set to be spatially separated, and a switching power supply circuit and the transceiver circuit of the RF communication are disposed in different planes. The PLC and the RF communication are physically isolated, which can reduce the spatial radiation interference from a physical perspective.

In the embodiments of the present disclosure, the physically isolating the PLC and the RF communication may include:
disposing the power interference suppression circuit separately in the transceiver circuit of the PLC, the transceiver circuit of the RF communication, and the carrier power amplifier.

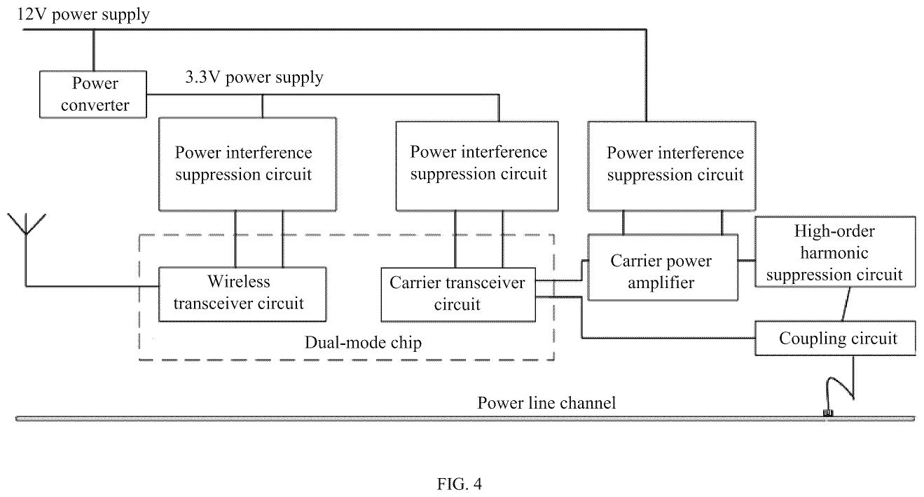

FIG. 4 is a schematic structural diagram of a circuit of the dual-mode converged communication according to an embodiment of the present disclosure. As shown in FIG. 4, a dual-mode converged communication device is powered by an external 12V power supply of a terminal, where a digital part is powered by a 3.3V power supply output by the external 12V power supply through an internal power converter, and a power amplifier circuit of a carrier part is powered by the 12V power supply. In order to prevent an interference signal from an external power supply from being coupled into a dual-mode communication chip to affect wireless reception sensitivity, it is necessary to separately add the power interference suppression circuit to 3.3V power supplies of a wireless transceiver circuit (namely, the transceiver circuit of the RF communication) and a carrier transceiver circuit (namely, the transceiver circuit of the PLC). A decoupling capacitor and a magnetic bead are used to suppress interference, and two power supply planes are segmented to prevent high-frequency interference due to mutual coupling between the power supplies of the wireless transceiver circuit and the carrier transceiver circuit. In addition, an interference suppression circuit is also added to power supply and output sides of the carrier power amplifier to prevent reception sensitivity of a wireless signal from being affected because a high-order harmonic generated when the power amplifier outputs a high-power signal flows back into a 12V power network.

In the embodiments of the present disclosure, the physically isolating the PLC and the RF communication may include:
disposing the digital baseband and the trench between the chip of the PLC and the chip of the RF communication to spatially isolate the chip of the PLC and the chip of the RF communication.

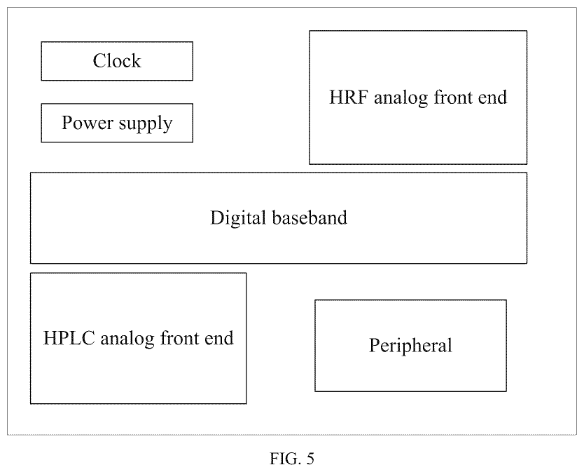

FIG. 5 is a schematic structural diagram of a layout of the dual-mode chip according to an embodiment of the present disclosure. As shown in FIG. 5, two easily interfered analog front ends of the PLC and the RF communication can be disposed at diagonal positions to reduce mutual interference. An HRF analog front end of the RF communication (namely, the chip of the RF communication) is disposed in an upper right corner, an HPLC analog front end of the PLC (namely, the chip of the PLC) is disposed in a lower left corner, and digital baseband and trenching technologies are used for spatial isolation in the middle. To reduce impacts of a digital baseband signal and a power line carrier signal on the analog front end of the RF communication, a peripheral part can be disposed in a lower right corner away from the analog front end of the RF communication, and a clock circuit and a power supply circuit can be disposed in an upper left corner.

In the embodiments of the present disclosure, the physically isolating the PLC and the RF communication may include:
setting the RF antenna, the RF filtering communication circuit, and the high-speed carrier power line coupling loop to be spatially separated, where the RF antenna is a spring antenna.

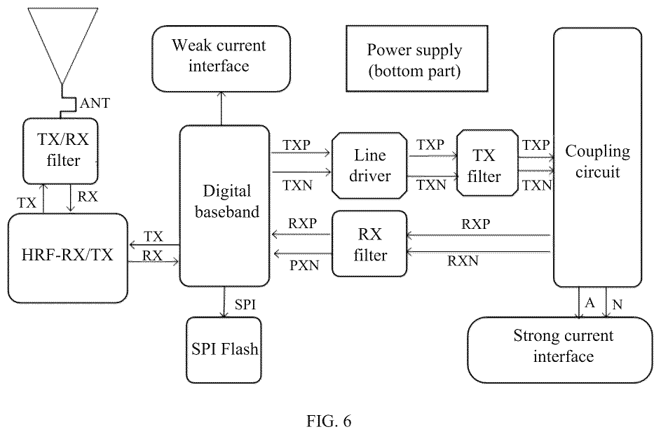

FIG. 6 is a schematic structural diagram of a layout of the dual-mode converged communication unit according to an embodiment of the present disclosure. As shown in FIG. 6, the RF antenna, the RF filtering communication circuit, and the high-speed carrier power line coupling loop can be spatially separated based on spatial distribution of the dual-mode converged communication unit. In FIG. 6, RX represents reception, TX represents transmission, RXN and RXP represent differential input ends, TXN and TXP represent differential output ends, SPI is abbreviated from serial peripheral interface, and SPI Flash represents a flash storage device that performs an operation through a serial interface. ANT is a type of wireless transmission protocol. In order to make the antenna easier to radiate and absorb noise interference generated on a Printed Circuit Board (PCB), an RF part of a communication unit in the embodiments of the present disclosure can use the spring antenna to receive and send a signal, making it easier to radiate and absorb the noise interference generated on the PCB.

In the embodiments of the present disclosure, the physically isolating the PLC and the RF communication may include:
disposing the switching power supply circuit and the transceiver circuit of the RF communication in the different planes.

Specifically, the switching power supply circuit itself is a strong interference source, and pulse width modulation (PWM) of a switching power supply generates a voltage fluctuation, resulting in high-frequency switching noise. Therefore, the switching power supply circuit and the transceiver circuit of the RF communication can be disposed in two planes to reduce spatial interference. In addition, the switching power supply can be used to support pulse frequency modulation (PFM). The PFM can reduce an impact of noise through frequency modulation. In addition to taking a measure on the circuit to suppress electromagnetic interference to the circuit, effective electromagnetic shielding and filtering can also be carried out on the switching power supply. A shielding box is used for the electromagnetic shielding, and a two-stage resonant logic circuit (LC) is used at an output end of the switching power supply for the filtering, thereby reducing signal radiation and interference.

In the embodiments of the present disclosure, the configuration method may further include:
optimizing a peripheral operating frequency of the CPU and a filtering parameter of a power pin.

In the embodiments of the present disclosure, the optimizing a peripheral operating frequency of the CPU and a filtering parameter of a power pin may include:
connecting the power pin and a resistor in series; and/or
connecting the power pin and a capacitor in parallel.

Specifically, the peripheral operating frequency of the CPU and the filtering parameter of the power pin can be further optimized to reduce out-of-band stray interference. In an example, the peripheral operating frequency of the CPU is very high. A peripheral output pin of the CPU is connected in series to the resistor to achieve impedance matching, so as to reduce external radiated interference of the output pin.

In another example, the power pin of the CPU needs to be specially processed to reduce a noise output. The power pin of the CPU is connected in parallel to pF-level and nF-level multilayer ceramic capacitors (MLCCs) to filter out noise generated by low and high frequencies. Preferably, the capacitor may be a 100 nF capacitor and/or a 100 pF capacitor. A formula for calculating decoupling capacitance can be as follows.

For a 0805 MLCC, L=1 nH, and the operating frequency of the RF communication ranges from 470 MHz to 510 MHz. A frequency of 500 MHz is taken as an example for calculation.

According to a following formula, it is obtained that C=100 pF:

$${f}_{c} = \frac{1}{2 π \sqrt{LC}} = \frac{1}{20 π \sqrt{10 LC}} MHz = \frac{1}{2 π \sqrt{10 C ( pF )}} MHz .$$

For the 0805 MLCC, L=1 nH, and a new operating frequency ranging from 0.7 MHz to 12 MHz is provided for the HPLC. A frequency of 5 MHz is taken as an example for calculation.

According to the above formula, it is obtained that C=100 pF.

Therefore, the power pin of the CPU is connected in parallel to the 100 nF and 100 pF capacitors to better filter out the noise generated by the low and high frequencies.

In the embodiments of the present disclosure, the configuration method may further include:
disposing a bandpass filter on a transmitting loop of the PLC.

Specifically, the bandpass filter can be disposed on the transmitting loop of the PLC to optimize a filter parameter of the transmitting loop of the PLC, thereby reducing out-of-band stray interference to transmission in the HPLC. An output signal of a digital-to-analog converter (DAC) of the HPLC needs to be amplified by an external power amplifier circuit before being output. Although strength of the signal is improved, out-of-band noise is also amplified. It is necessary to add a 470 MHz to 510 MHz bandpass filter circuit to an output end of the power amplifier circuit to reduce an impact of out-of-band noise generated by the transmission in the HPLC on the reception sensitivity of the RF communication.

In the embodiments of the present disclosure, the bandpass filter may be a sixth-order bandpass filter, and the sixth-order bandpass filter may include a third-order HPF and a third-order LPF. Preferably, inductance of the third-order HPF may be 16.93 uH, capacitance of the third-order HPF may be 3.38 nF, inductance of the third-order LPF may be 15.6 nH, and capacitance of the third-order LPF may be 12.5 pF.

Specifically, a third-order Butterworth LPF with a cutoff frequency of 510 MHz is designed as follows:

Step 1: Calculate a ratio M of a cutoff frequency of the to-be-designed filter to a cutoff frequency of a reference filter.

M=cutoff frequency of the to-be-designed filter/cutoff frequency of the reference filter-510 MHz/(1/2π) Hz=510000000 Hz/0.159154 Hz=3204443495.

Step 2: Divide all component parameter values of the reference filter by M to obtain component parameter values when the cutoff frequency has been transformed to the cutoff frequency 510 MHz of the to-be-designed filter.

$$L ( new ) = L ( old ) / M = 1. H / 3204443495 = 3.121 \times {10}^{- 10} H ;$$

$$C ( new ) = C ( old ) / M = 2. F / 3204443495 = 6.241 \times {10}^{- 10} F .$$

Step 3: Calculate a ratio K of characteristic impedance of the to-be-designed filter to characteristic impedance of the reference filter.

K=characteristic impedance of the to-be-designed filter/characteristic impedance of the reference filter=50 Ω/1 Ω=50.

Step 4: For the filter calculated in the step 2, multiply all inductance component parameter values by K, and divide all capacitance component parameter values by K, such that parameter values of the designed third-order fixed-K LPF with the characteristic impedance of 50Ω and the cutoff frequency of 510 MHz are obtained.

$$L ( new ) = L ( old ) \times K = 3.121 \times {10}^{- 10} H \times 50 = 1.56033 \times {10}^{- 8} H = 15.6 nH ;$$

$$C ( new ) = C ( old ) / K = 6.241 \times {10}^{- 10} F / 50 = 1.25 \times {10}^{- 11} F = 12.5 pF .$$

According to the above calculation formulas, it can be concluded that the inductance of the third-order LPF may be 15.6 nH and the capacitance of the third-order LPF may be 12.5 pF. A simulation result shows that adding an LPF ensures output of a useful signal below 510 MHz, which has a suppressive effect on signals at other frequencies.

A third-order Butterworth HPF with a cutoff frequency of 470 MHz is designed as follows:

Step 1: Calculate a ratio M of a cutoff frequency of the to-be-designed filter to a cutoff frequency of a reference filter.

M=cutoff frequency of the to-be-designed filter/cutoff frequency of the reference filter=470 MHz/(1/2π) Hz=470000000 Hz/0.159154 Hz=2953114593.

Step 2: Divide all component parameter values of the reference filter by M to obtain component parameter values when the cutoff frequency has been transformed to the cutoff frequency 470 MHz of the to-be-designed filter.

$$L ( new ) = L ( old ) / M = 1. H / 2953114593 = 3.386 \times {10}^{- 10} H ;$$

$$C ( new ) = C ( old ) / M = 0.5 F / 2953114593 = 1.693 \times {10}^{- 10} F .$$

Step 3: Calculate a ratio K of characteristic impedance of the to-be-designed filter to characteristic impedance of the reference filter.

K=characteristic impedance of the to-be-designed filter/characteristic impedance of the reference filter=50 Ω/1 Ω=50.

Step 4: For the filter calculated in the step 2, multiply all inductance component parameter values by K, and divide all capacitance component parameter values by K, such that parameter values of the designed third-order fixed-K HPF with the characteristic impedance of 50Ω and the cutoff frequency of 470 MHz are obtained.

$$L ( new ) = L ( old ) \times K = 3.386 \times {10}^{- 10} H \times 50 = 1.693 \times {10}^{- 8} H = 16.93 uH ;$$

$$C ( new ) = C ( old ) / K = 1.693 \times {10}^{- 10} F / 50 = 3.38 \times {10}^{- 12} F = 3.38 nF .$$

According to the above calculation formulas, it can be concluded that the inductance of the third-order HPF may be 16.93 uH and the capacitance of the third-order HPF may be 3.38 nF. A simulation result shows that adding an HPF ensures output of a useful signal above 470 MHz, which has a suppressive effect on signals at other frequencies.

In the embodiments of the present disclosure, in the chip and circuit design, the physical layer, the chip layout, and the communication unit circuit layout can be designed by deploying the HPLC and the RF communication in the different spatial planes to reduce the spatial radiation interference. The switching power supply is shielded and filtered. A transmitting circuit is designed to include the filter to perform out-of-band suppression to reduce dual-channel interference. It should be noted that the configuration method for dual-mode converged communication in the embodiments of the present disclosure may be any one of the configuration methods in the above embodiments, or a combination of the configuration methods in the above embodiments to improve a success rate of the dual-mode communication.

The embodiments of the present disclosure further provide a configuration apparatus for dual-mode converged communication, where the dual-mode converged communication includes PLC and RF communication, and the configuration apparatus includes:
a determining module configured to determine a first operating frequency band of the PLC and a second operating frequency band of the RF communication; and
a configuration module configured to configure a second frequency band number of the second operating frequency band based on a first frequency band number of the first operating frequency band, such that a high-order harmonic frequency of a first operating clock of the PLC and a high-order harmonic frequency of a second operating clock of the RF communication do not overlap with the first operating frequency band or the second operating frequency band.

In the embodiments of the present disclosure, the configuration module is further configured to:
obtain the first frequency band number of the first operating frequency band;
search a frequency band number configuration table based on the first frequency band number, where the frequency band number configuration table includes a combined frequency band number including the first frequency band number and the second frequency band number, and a first operating clock and a second operating clock that correspond to the combined frequency band number;
determine whether high-order harmonic frequencies of a first operating clock and a second operating clock that correspond to any combined frequency band number fall within the first operating frequency band and the second operating frequency band;
when determining that the high-order harmonic frequencies of the first operating clock and the second operating clock that correspond to the any combined frequency band number do not fall within the first operating frequency band or the second operating frequency band, determine a second frequency band number in the any combined frequency band number as a candidate second frequency band number; and
configure any candidate second frequency band number as the second frequency band number.

In the embodiments of the present disclosure, the configuration apparatus further includes:
an establishment module configured to establish the frequency band number configuration table.

In the embodiments of the present disclosure, the establishment module is further configured to:
permute and combine the first frequency band number and the second frequency band number to obtain a plurality of combined frequency band numbers; and
determine a first operating clock and a second operating clock that correspond to each of the combined frequency band numbers.

In the embodiments of the present disclosure, the establishment module is further configured to:
obtain a first clock frequency of the PLC and a second clock frequency of the RF communication;
obtain a first frequency doubling coefficient, a first frequency division coefficient, a second frequency doubling coefficient, and a second frequency division coefficient for each combined frequency band number;
determine the first operating clock based on the first frequency doubling coefficient, the first frequency division coefficient, and the first clock frequency; and
determine the second operating clock based on the second frequency doubling coefficient, the second frequency division coefficient, and the second clock frequency.

In the embodiments of the present disclosure, the configuration apparatus further includes:
a rating module configured to rate a neighboring STA of a current STA to obtain an alternative proxy STA;
a first judgment module configured to determine whether a communication success rate of a main proxy STA corresponding to the current STA is greater than a first threshold;
a second judgment module configured to: when the communication success rate of the main proxy STA is greater than the first threshold, determine whether a delay of the main proxy STA is less than a second threshold; and
a first selection module configured to: when the delay of the main proxy STA is less than second threshold, select the main proxy STA to send data.

In the embodiments of the present disclosure, the configuration apparatus further includes:
a second selection module configured to: when the communication success rate of the main proxy STA is less than or equal to the first threshold and/or the delay of the main proxy STA is greater than or equal to the second threshold, select the alternative proxy STA to send the data.

In the embodiments of the present disclosure, the rating module is further configured to:
determine a proxy quality rating of the neighboring STA of the current STA based on an uplink communication success rate, signal strength, a signal-to-noise ratio, a hierarchy, and a quantity of transmitted data frames that are of the neighboring STA;
sort the neighboring STA in a descending order based on the proxy quality rating; and
select a preset quantity of top-ranked neighboring nodes as the alternative proxy STA.

In another example embodiment, the configuration apparatus for dual-mode converged communication includes a processor. The processor is configured to execute the above program modules stored in a memory, including the determining module, the configuration module, the establishment module, the rating module, a first judgment module, a second judgment module, a first selection module, and a second selection module.

The configuration apparatus for dual-mode converged communication executes the above method to implement the corresponding process in each method in the embodiments of the present disclosure, which is not described herein again for simplicity.

The embodiments of the present disclosure further provide a dual-mode converged communication system. The dual-mode converged communication system is configured by using the above configuration method for dual-mode converged communication.

Those skilled in the art should understand that the embodiments of the present disclosure may be provided as a method, a system, or a computer program product. Therefore, the present disclosure may a form of hardware only embodiments, software only embodiments, or embodiments with a combination of software and hardware. Moreover, the present disclosure may be in a form of a computer program product that is implemented on one or more computer-usable storage media (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that each process and/or each block in the flowcharts and/or the block diagrams and a combination of a process and/or a block in the flowcharts and/or the block diagrams can be implemented by computer program instructions. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or in one or more blocks in the block diagrams.

These computer program instructions may be stored in a computer-readable memory that can instruct a computer or another programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, such that a series of operating steps are performed on the computer or the another programmable device to generate computer-implemented processing, and instructions executed on the computer or the another programmable device provide steps for implementing a specific function in one or more processes in the flowcharts and/or one or more blocks in the block diagrams.

In a typical configuration, a computing device includes one or more CPUs, an input/output (I/O) interface, a network interface, and a memory.

The memory may include a non-persistent memory, a random access memory (RAM) and/or a non-volatile memory in a computer-readable medium, such as a read-only memory (ROM) or a flash RAM. The memory is an example of the computer-readable medium.

The computer-readable medium includes persistent, non-persistent, removable, and non-removable media, and storage of information may be implemented by any method or technology. The information may be a computer-readable instruction, a data structure, a module of a program, or other data. Examples of a computer storage medium include, but are not limited to, a phase-change random access memory (PRAM), a static random access memory (SRAM), a dynamic random access memory (DRAM), other types of RAMs, a ROM, an electrically erasable programmable read-only memory (EEPROM), a flash memory or another memory technology, a compact disc read-only memory (CD-ROM), a digital versatile disk (DVD) or another optical storage device, a magnetic cassette tape, and a magnetic tape disk storage device or another magnetic storage device or any other non-transmission medium, which can be used to store information that can be accessed by a computing device. The computer-readable medium, as defined herein, excludes transitory computer-readable media, such as modulated data signals and carriers.

It should also be noted that the term “comprise”, “include”, or any other variant thereof is intended to encompass a non-exclusive inclusion, such that a process, method, product, or device that includes a series of elements includes not only those elements, but also other elements not explicitly listed, or elements that are inherent to such a process, method, product, or device. Without more restrictions, an element defined by the phrase “including a . . . ” does not exclude the presence of another same element in a process, method, product, or device that includes the element.

The above described are merely embodiments of the present disclosure, which are not intended to limit the present disclosure. Various changes and modifications can be made to the present disclosure by those skilled in the art. Any modifications, equivalent replacements, and improvements made within the spirit and principle of the present disclosure should be included within the protection scope of the claims of the present disclosure.

1. A configuration method for dual-mode converged communication, wherein the dual-mode converged communication comprises power line communication (PLC) and radio frequency (RF) communication, and the configuration method comprises:
determining a first operating frequency band of the PLC and a second operating frequency band of the RF communication; and
configuring a second frequency band number of the second operating frequency band based on a first frequency band number of the first operating frequency band, to enable a high-order harmonic frequency of a first operating clock of the PLC and a high-order harmonic frequency of a second operating clock of the RF communication not to overlap with the first operating frequency band or the second operating frequency band.

2. The configuration method according to claim 1, wherein the configuring a second frequency band number of the second operating frequency band based on a first frequency band number of the first operating frequency band, to enable a high-order harmonic frequency of a first operating clock of the PLC and a high-order harmonic frequency of a second operating clock of the RF communication not to overlap with the first operating frequency band or the second operating frequency band specifically comprises:
obtaining the first frequency band number of the first operating frequency band;
searching a frequency band number configuration table based on the first frequency band number, wherein the frequency band number configuration table comprises a combined frequency band number comprising the first frequency band number and the second frequency band number, and a first operating clock and a second operating clock that correspond to the combined frequency band number;
determining whether high-order harmonic frequencies of a first operating clock and a second operating clock that correspond to any combined frequency band number fall within the first operating frequency band and the second operating frequency band;
when determining that the high-order harmonic frequencies of the first operating clock and the second operating clock that correspond to the any combined frequency band number do not fall within the first operating frequency band or the second operating frequency band, determining a second frequency band number in the any combined frequency band number as a candidate second frequency band number; and
configuring any candidate second frequency band number as the second frequency band number.

3. The configuration method according to claim 2, further comprising:
establishing the frequency band number configuration table.

4. The configuration method according to claim 3, wherein the establishing the frequency band number configuration table comprises:
permuting and combining the first frequency band number and the second frequency band number to obtain a plurality of combined frequency band numbers; and
determining a first operating clock and a second operating clock that correspond to each of the combined frequency band numbers.

5. The configuration method according to claim 4, wherein the determining a first operating clock and a second operating clock that correspond to each of the combined frequency band numbers comprises:
obtaining a first clock frequency of the PLC and a second clock frequency of the RF communication;
obtaining a first frequency doubling coefficient, a first frequency division coefficient, a second frequency doubling coefficient, and a second frequency division coefficient for each combined frequency band number;
determining the first operating clock based on the first frequency doubling coefficient, the first frequency division coefficient, and the first clock frequency; and
determining the second operating clock based on the second frequency doubling coefficient, the second frequency division coefficient, and the second clock frequency.

6. The configuration method according to claim 5, wherein the first operating clock meets a formula (1):
f_{wk-PLC}=P_{PLC}/Q_{PLC}*f_{osc-PLC}; (1)
wherein f_{wk-PLC} represents the first operating clock, P_{PLC} represents the first frequency doubling coefficient, Q_{PLC} represents the first frequency division coefficient, and f_{osc-PLC} represents the first clock frequency.

7. The configuration method according to claim 5, wherein the second operating clock meets a formula (2):
f_{wk-RF}=P_{RF}/Q_{RF}*f_{osc-RF}; (2)
wherein f_{wk-RF} represents the second operating clock, P_{RF} represents the second frequency doubling coefficient, Q_{RF} represents the second frequency division coefficient, and f_{osc-RF} represents the second clock frequency.

8. The configuration method according to claim 1, further comprising:
rating a neighboring station (STA) of a current STA to obtain an alternative proxy STA;
determining whether a communication success rate of a main proxy STA corresponding to the current STA is greater than a first threshold;
when the communication success rate of the main proxy STA is greater than the first threshold, determining whether a delay of the main proxy STA is less than a second threshold; and
when the delay of the main proxy STA is less than the second threshold, selecting the main proxy STA to send data.

9. The configuration method according to claim 8, further comprising:
when the communication success rate of the main proxy STA is less than or equal to the first threshold and/or the delay of the main proxy STA is greater than or equal to the second threshold, selecting the alternative proxy STA to send the data.

10. The configuration method according to claim 8, wherein the rating a neighboring STA of a current STA to obtain an alternative proxy STA comprises:
determining a proxy quality rating of the neighboring STA of the current STA based on an uplink communication success rate, signal strength, a signal-to-noise ratio, a hierarchy, and a quantity of transmitted data frames that are of the neighboring STA;
sorting the neighboring STA in a descending order based on the proxy quality rating; and
selecting a preset quantity of top-ranked neighboring nodes as the alternative proxy STA.

11. The configuration method according to claim 1, further comprising:
physically isolating the PLC and the RF communication.

12. The configuration method according to claim 11, wherein the physically isolating the PLC and the RF communication comprises:
disposing a power interference suppression circuit separately in a transceiver circuit of the PLC, a transceiver circuit of the RF communication, and a carrier power amplifier.

13. The configuration method according to claim 11, wherein the physically isolating the PLC and the RF communication comprises:
disposing a digital baseband and a trench between a chip of the PLC and a chip of the RF communication to spatially isolate the chip of the PLC and the chip of the RF communication.

14. The configuration method according to claim 11, wherein the physically isolating the PLC and the RF communication comprises:
setting an RF antenna, an RF filtering communication circuit, and a high-speed carrier power line coupling loop to be spatially separated.

15. The configuration method according to claim 11, wherein the physically isolating the PLC and the RF communication comprises:
disposing a switching power supply circuit and a transceiver circuit of the RF communication in different planes.

16. The configuration method according to claim 1, further comprising:
optimizing a peripheral operating frequency of a central processing unit (CPU) and a filtering parameter of a power pin.

17. The configuration method according to claim 16, wherein the optimizing a peripheral operating frequency of a CPU and a filtering parameter of a power pin comprises:
connecting the power pin and a resistor in series; and/or
connecting the power pin and a capacitor in parallel.

18. The configuration method according to claim 1, further comprising:
disposing a bandpass filter on a transmitting loop of the PLC.

19. The configuration method according to claim 18, wherein the bandpass filter is a sixth-order bandpass filter, and the sixth-order bandpass filter comprises a third-order high-pass filter (HPF) and a third-order low-pass filter (LPF).

20. A configuration apparatus for dual-mode converged communication, wherein the dual-mode converged communication comprises PLC and RF communication, and the configuration apparatus comprises:
a determining module configured to determine a first operating frequency band of the PLC and a second operating frequency band of the RF communication; and
a configuration module configured to configure a second frequency band number of the second operating frequency band based on a first frequency band number of the first operating frequency band, to enable a high-order harmonic frequency of a first operating clock of the PLC and a high-order harmonic frequency of a second operating clock of the RF communication not to overlap with the first operating frequency band or the second operating frequency band.

21. The configuration apparatus according to claim 20, wherein the configuration module is further configured to:
obtain the first frequency band number of the first operating frequency band;
search a frequency band number configuration table based on the first frequency band number, wherein the frequency band number configuration table comprises a combined frequency band number comprising the first frequency band number and the second frequency band number, and a first operating clock and a second operating clock that correspond to the combined frequency band number;
determine whether high-order harmonic frequencies of a first operating clock and a second operating clock that correspond to any combined frequency band number fall within the first operating frequency band and the second operating frequency band;
when determining that the high-order harmonic frequencies of the first operating clock and the second operating clock that correspond to the any combined frequency band number do not fall within the first operating frequency band or the second operating frequency band, determine a second frequency band number in the any combined frequency band number as a candidate second frequency band number; and
configure any candidate second frequency band number as the second frequency band number.

22. The configuration apparatus according to claim 21, further comprising:
an establishment module configured to establish the frequency band number configuration table.

23. The configuration apparatus according to claim 22, wherein the establishment module is further configured to:
permute and combine the first frequency band number and the second frequency band number to obtain a plurality of combined frequency band numbers; and
determine a first operating clock and a second operating clock that correspond to each of the combined frequency band numbers.

24. The configuration apparatus according to claim 23, wherein the establishment module is further configured to:
obtain a first clock frequency of the PLC and a second clock frequency of the RF communication;
obtain a first frequency doubling coefficient, a first frequency division coefficient, a second frequency doubling coefficient, and a second frequency division coefficient for each combined frequency band number;
determine the first operating clock based on the first frequency doubling coefficient, the first frequency division coefficient, and the first clock frequency; and
determine the second operating clock based on the second frequency doubling coefficient, the second frequency division coefficient, and the second clock frequency.

25. The configuration apparatus according to claim 20, further comprising:
a rating module configured to rate a neighboring STA of a current STA to obtain an alternative proxy STA;
a first judgment module configured to determine whether a communication success rate of a main proxy STA corresponding to the current STA is greater than a first threshold;
a second judgment module configured to: when the communication success rate of the main proxy STA is greater than the first threshold, determine whether a delay of the main proxy STA is less than a second threshold; and
a first selection module configured to: when the delay of the main proxy STA is less than the second threshold, select the main proxy STA to send data.

26. The configuration apparatus according to claim 25, further comprising:
a second selection module configured to: when the communication success rate of the main proxy STA is less than or equal to the first threshold and/or the delay of the main proxy STA is greater than or equal to the second threshold, select the alternative proxy STA to send the data.

27. The configuration apparatus according to claim 25, wherein the rating module is further configured to:
determine a proxy quality rating of the neighboring STA of the current STA based on an uplink communication success rate, signal strength, a signal-to-noise ratio, a hierarchy, and a quantity of transmitted data frames that are of the neighboring STA;
sort the neighboring STA in a descending order based on the proxy quality rating; and
select a preset quantity of top-ranked neighboring nodes as the alternative proxy STA.

28. A dual-mode converged communication system, wherein the dual-mode converged communication system is configured by using the configuration method for dual-mode converged communication according to claim 1.
